(19) United States
(12) Patent Application Publication
(10) Pub. No.: US 2003/0040589 A1
(43) Pub. Date: Feb. 27, 2003

(54) Process for controlled anionic stereospecific polymerization of styrenes

(76) Inventors: Jean-Marc Marechal, Pessac (FR); Bindushree Radhakrishnan, Minneapolis, MN (US); Alain Deffieux, Bordeaux (FR); Marianne Barbier, Saint Marcel (FR)

Correspondence Address: Ira J. Schultz, DENNISON, SCHULTZ & DOUGHERTY, Suite 612, 1745 Jefferson Davis Highway,, Arlington, VA, 22202, US

(21) Appl. No.: 10/132,724

(22) Filed: Apr. 26, 2002

(30) Foreign Application Priority Data
May 17, 2001 (FR) 01/06518

(51) Int. Cl. C08F 4/46; B01J 31/00

(52) U.S. Cl. 526/173; 526/335; 526/346; 502/150; 502/152; 502/153; 502/154; 502/155; 502/167

(57) ABSTRACT

A polymerization process for styrene derivatives in which a styrene monomer is placed in contact with a catalyst system in a solvent, including at least:

a) an alkaline derivative (I) and

b) an alkyl magnesium derivative (II)

represented by the formulae:

*R—X—Mₜ (I)

where R is an alkyl, cycloalkyl or aryl group, possibly replaced, and also able to carry heteroatoms such as O, N, or S, or a carbon atom; and where Mₜ is an alkaline metal or alkaline earth metal, and

*R′—Mg—X—R″ (II)

where R′ and R″ are alkyl, cycloalkyl or aryl groups, possibly replaced, and also able to carry heteroatoms; X is a heteroatom such as O, N, or S, or a carbon atom, and Mg is an atom of magnesium. This process is able to control group stereoregularity in a range that moves gradually from structures with a strong isotactic tendency to those with a strong syndiotactic tendency.

### FIELD OF THE INVENTION

This invention concerns a process for the controlled anionic stereo specific polymerization of styrenes with the aid of a specific catalyst and the stereo-uniform polymers and co-polymers that are produced as a result.

### DESCRIPTION OF RELATED ART

Stereo specific isotactic and syndiotactic polymerization of styrenes using Ziegler-Natta catalysts or metallocenes with a transition metal complex base (mainly Ti, Zr, Ni) is already well known. Partial isospecific polymerization of styrenes using anionic primers or catalysts is also a familiar method. Crystallizable polystyrene synthesis with a strong syndiotactic tendency was obtained for the first time by Ishihara, using titanium based catalysts (semi-metallocenes) in the presence of methyl-aluminoxane, and this is described in the patents EP 0201615 and EP 0224097 under the name of Idemitsu Kosan. The polymerization produces semi-crystalline polymers with a high melting point, but that on the other hand, are absolutely insoluble in standard organic solvents, and are very difficult to construct. Moreover the polymerization is not controlled, meaning that the active areas are not persistent or constant. This does not permit precision control of the polymer molecular mass, or the possibility of end group functionality, or even co-polymer block synthesis.

Crystallizable isotactic polystyrene synthesis was obtained at the very beginning of the development of Ziegler-Natta catalysts. However isotactic polymers have always been obtained blended with an atactic fraction of variable importance, imposing fractionation in the case of industrial application.

As in the case of syndiotactic polystyrenes obtained from metallocenes, this polymerization is neither controlled nor continuous. It is also possible to generate crystalline isotactic polystyrenes using anionic type catalysts, as described in patent U.S. Pat. No. 3,161,625 by Monsanto Chemical. Once again, these isotactic polystyrenes represent only a fraction, in variable proportion, of the total polymer produced, meaning that generally fractionation is necessary. If it has been described recently, co-polymer block synthesis (polystyrene-b-polydiene for example) will permit only the production of a stereo specific fraction mixed with homopolymer groups composed of the two blocks. Moreover, di-block co-polymer syntheses are produced from polybutadiene or polyisoprene blocks prepared in classical anionic polymerization conditions during the initial stage (alkyl-lithium priming), and the stereoregulation is obtained only after the polystyrene block has been primed. The efficacy of this priming system is only partial and results in a strong proportion of homopolyisoprene groups.

### SUMMARY OF THE INVENTION

The object of this invention is to provide a stereospecific anionic polymerization process for styrenes that can control the stereoregularity of the groups in a range moving gradually from strongly isotactic structures (90% for example) to those that are strongly syndiotactic (75% for example).

This invention is aimed at a polymerization process for styrene derivatives in which a styrene monomer is placed in contact with a catalyst system in a solvent, including at least:

a) an alkaline derivative (I) and

b) an alkyl magnesium derivative (II)

represented by the formulae:

*R—X—Mₜ (I)

where R is an alkyl, cycloalkyl or aryl group, possibly replaced, and also able to carry heteroatoms such as O, N, or S, or a carbon atom; and where Mₜ is an alkaline metal or alkaline earth metal, and

*R′—Mg—X—R″ (II)

where R′ and R″ are alkyl, cycloalkyl or aryl groups, possibly replaced, and also able to carry heteroatoms; X is a heteroatom such as O, N, or S, or a carbon atom, and Mg is an atom of magnesium.

This invention also aims at presenting a polymerization catalyst for styrenic derivatives composed of a blend of at least one type (I) derivative and at least one type (II) derivative, as well as the controlled tactic polystyrenes obtained through this process.

### DETAILED DESCRIPTION OF THE INVENTION

The feature of this invention lies in the use of catalyst systems for styrenic derivatives; the systems being composed of a blend of type (I) and type (II) derivatives in proportions that can vary in a ratio (I) (II) between 0.01 and 10. Several type (I) or type (II) derivatives like those described above can be used together.

The solvents preferably used are hydrocarbon solvents. However, in certain special cases such as synthesis of polymers with a syndiotactic tendency, polymerization can be performed in solvents that are more polar or with more sequestering agents such as ethers or THF. The polymerization in this invention is carried out at a temperature that generally ranges between −80° C. and +120° C.

Catalytic complex synthesis can be performed previously in conditions at a temperature between −40° C. and +50° C. This can also be performed in situ with the addition of one or more reagents directly in the polymerization medium.

Unlike previous anionic processes, in this process, all the groups present the advantage of possessing the same tactic levels, permitting the use of polymers with different stereospecific natures without the need for fractionation.

Moreover, the persistent nature of the propagator areas during group growth, typical of continuous anionic polymerization, permits control of their size, molecular distribution, terminal functionality, and to synthesise with the copolymer diene blocks that possess polystyrene blocks with varying tacticity, for example ₜPS-PD type diblocks or ₜPS-PD-ₜPS type tri-blocks, where ₜPS represents a PS block with controlled tacticity, and PD represents a polydiene block.

### EXAMPLES

Polymer Properties:

Tacticity is determined by carbon 13 nuclear magnetic resonance (NMR)using a Bruker AC-250 FT-NMR instrument.

The spectra are carried out at room temperature in CDCL₃. The percentages in isotactic (mm), syndiotactic (rr) and heterotactic (mr) triads are obtained through deconvolution of the RMN spectrum of the quaternary carbon C₁ of the phenyl group. The value of the isotactic pentade (mmm) is determined from the band at 147 ppm according to the procedure published (for example) in the article by T.Kawamura et al. Makromol. Chem. 1979, vol. 180, page 2001.

The average number of molecular masses and the polymolecularity of the polymers produced by the synthesis are determined by size exclusion chromatography (SEC) on Varian equipment mounted with a JASCO HPLC pump, Type: 880-PU, a UV detector, a refractometer, and TSK gel columns calibrated according to standard polystyrenes.

The efficacy of the catalyst is calculated according to the ratio Mnₒ* yield on the base of a continuous polymerization process Mnₑₓₚ (end group reactions and transfer are unimportant) Mnₒ is calculated according to the ratio of the monomer masse introduced into the concentration as a primer. Theoretically, a polymer chain is formed by the metal atom introduced. The metal that is taken into account is that introduced in defect. Mnₑₓₚ is determined by SEC chromatography.

Fractionation tests were performed in boiling butan-2-one. All the samples, including those with the highest isotactic or syndiotactic triad contents resulted in 100% soluble polystyrene. Together with the polymolecularity values, these results agree with the presence of a single site of active stereospecific polymerization.

### Example 1

In a dry 100 ML flask equipped with a magnetic agitator, and placed at 20° C., the following are introduced gradually: 2 ml (2.10⁻⁴ mol) of ter-lithium butanolate solution in cyclohexane; 2 ml of n,s dibutylmagnesium solution (2.10⁻⁴ mol) in cyclohexane; and 40 ml of previously dried cyclohexane. Then 2.2 ml (2 gr.) of previously dried styrene is added. The reaction time is 8 hours, then the polymerization is stopped with the addition of 1 ml of methanol. The polymer is precipitated in methanol, filtered, then dried under vacuum for 12 hours.

### Example 2

In a dry 100 ML flask equipped with a magnetic agitator, and placed at 20° C., the following are introduced gradually: 19.2 mg (2.10⁻⁴ mol) of ter-sodium butanolate solution; 2 ml of n,s dibutylmagnesium solution (2.10⁻⁴ mol) in cyclohexane; and 40 ml of previously dried cyclohexane. Then 2.2 ml (2 gr.) of previously dried styrene is added. The reaction time is 12 hours, then the polymerization is stopped with the addition of 1 ml of methanol. The polymer is precipitated in methanol, filtered, then dried under vacuum for 12 hours.

### Example 3

In a dry 100 ML flask equipped with a magnetic agitator, and placed at 20° C., the following are introduced gradually: 22.4 mg (2.10⁻⁴ mol) of ter-potassium butanoate solution; 4 ml of n,s dibutylmagnesium solution (4.10⁻⁴ mol) in cyclohexane; and 40 ml of previously dried cyclohexane. Then 2.2 ml (2 gr.) of previously dried styrene is added. The reaction time is 12 hours, then the polymerization is stopped with the addition of 1 ml of methanol. The polymer is precipitated in methanol, filtered, then dried under vacuum for 12 hours.

### Example 4

In a dry 100 ML flask equipped with a magnetic agitator, and placed at 0° C., the following are introduced gradually: 22.4 mg (2.10⁻⁴ mol) of ter-potassium butanolate solution; 5 ml of n,s dibutylmagnesium solution (5.10⁻⁴ mol) in methylcyclohexane; and 40 ml of previously dried methylcyclohexane. Then 2.2 ml (2 gr.) of previously dried styrene is added. The reaction time is 8 hours, then the polymerization is stopped with the addition of 1 ml of methanol. The polymer is precipitated in methanol, filtered, then dried under vacuum for 12 hours.

### Example 5

In a dry 100 ML flask equipped with a magnetic agitator, and placed at −20° C., the following are introduced gradually: 22.4 mg (2.10⁻⁴ mol) of ter-potassium butanolate solution; 5 ml of n,s dibutylmagnesium solution (2.10⁻⁴ mol) in methylcyclohexane; and 40 ml of previously dried methylcyclohexane. The temperature is reduced to −40° C. then 2.2 ml (2 gr.) of dried styrene is added. The reaction time is 30 hours, then the polymerization is stopped with the addition of 1 ml of methanol. The polymer is precipitated in methanol, filtered, then dried under vacuum for 12 hours.

### Example 6

In a dry 100 ML flask equipped with a magnetic agitator, and placed at −40° C., the following are introduced gradually: 22.4 mg (2.10⁻⁴ mol) of ter-potassium butanolate solution; 5 ml of n,s dibutylmagnesium solution (2.10⁻⁴ mol) in methylcyclohexane; and 40 ml of previously dried methylcyclohexane. Then 2.2 ml (2 gr.) of dried styrene is added. The reaction time is 48 hours, then the polymerization is stopped with the addition of 1 ml of methanol. The polymer is precipitated in methanol, filtered, then dried under vacuum for 12 hours.

### Example 7

In a dry 100 ML flask equipped with a magnetic agitator, and placed at 0° C., the following are introduced gradually: 25.6 mg (2.10⁻⁴ mol) of potassium trimethylsilonate; 5 ml of n,s dibutylmagnesium solution (2.10⁻⁴ mol) in methylcyclohexane; and 40 ml of previously dried methylcyclohexane. Then 2.2 ml (2 gr.) of dried styrene is added. The reaction time is 48 hours, then the polymerization is stopped with the addition of 1 ml of methanol. The polymer is precipitated in methanol, filtered, then dried under vacuum for 12 hours.

### Example 8 (continuity control)

In a dry 100 ML flask equipped with a magnetic agitator, and placed at 20° C., the following are introduced gradually: 22.4 mg (2.10⁻⁴ mol) of potassium ter-potassium butanolate solution; 2 ml of n,s dibutylmagnesium solution (4.10⁻⁴ mol) in cyclohexane; and 40 ml of previously dried cyclohexane. Then an initial amount of 2.2 ml (2 gr.) of dried styrene is added. The reaction time is 1.5 hours, and a sample (a) is taken for analysis. Another amount of 5 ml (4.5 g) of dried styrene is added. The reaction time is 8 hours, then the polymerization is stopped with the addition of 1 ml of methanol. The polymer is precipitated in methanol, filtered, then dried under vacuum for 12 hours.

For the sample (a) the following measurements were calculated:

$$Mn = 19000 g . {mol}^{- 1} ; \frac{Mw}{Mn} = 1.3$$

$$And for the final polystyrene \text{:}$$

$$Mn = 50000 g . {mol}^{- 1} ; \frac{Mw}{Mn} = 1.3$$

It is established that all the polymer chains grow at the same speed without deactivation.

### Example 9 (Synthesis of a co-polymer block PS-b-PI)

In a dry 100 ML flask equipped with a magnetic agitator, and placed at 20° C., the following are introduced gradually: 22.4 mg (2.10⁻⁴ mol) of ter-potassium butanolate solution; 2 ml of n,s dibutylmagnesium solution (4.10⁻⁴ mol) in methylcyclohexane; and 40 ml of previously dried methylcyclohexane. Then an initial amount of 2.2 ml (2 gr.) of dried styrene is added. The reaction time is 5 hours, and a sample (b) is taken for analysis. Then 4.4 ml (3 g) of dried isoprene is added. The reaction time is 24 hours then the polymerization is stopped with the addition of 1 ml of methanol. The polymer is precipitated in methanol, filtered, then dried under vacuum for 12 hours.

On sample (b) that corresponds with the first polystyrene block, the following measurements were calculated:

$$Mn = 19000 g . {mol}^{- 1} ; \frac{Mw}{Mn} = 1.3 ; mm ( \% ) = 52 ; mr + rm ( \% ) = 33 ;$$

$$rr ( \% ) = 15$$

On the polystyrene-b-polyisoprene copolymer:

$$Mn = 34000 g . {mol}^{- 1} ; \frac{Mw}{Mn} = 1.3$$

The microstructure of the polyisoprene block was measured using NMR:

units 1.4=43%; units 1.2=5%; units 3.4=52%.

The polymerization results and the polymer properties for examples 1 to 8 are shown in Table 1, where mm, mr+rm, and rr represent the iso, hetero, and syndiotactic type chain formation proportions in the polymers:

TABLE 1

| Example | | Ip = Mw | | Primer | Mm | mr + rm | rr | Mmmm |
|---|---|---|---|---|---|---|---|---|
| N | Mn | Mn | Yield | efficiency | (%) | (%) | (%) | (%) |
| 1 | 74000 | 1.2 | 89% | 12% | 9 | 20.5 | 70.5 | 0 |
| 2 | 53000 | 1.3 | 81% | 15% | 27 | 27.5 | 45.5 | — |
| 3 | 7600 | 1.5 | 76.5% | 100% | 64 | 28 | 8 | 15.5 |
| 4 | 21000 | 1.6 | 40.0% | 19% | 74 | 21.5 | 4.5 | 24 |
| 5 | 210000 | 1.26 | 38.9% | 9% | 76 | 21.5 | 2.5 | 31 |
| 6 | 6400 | 1.4 | 5.0% | 8% | 86 | 14 | 0 | 44 |
| 7 | 14500 | 1.3 | 4 | 8% | 75 | 21 | 4 | 20 |
| 8a | 19000 | 1.3 | | | 63 | 29 | 8 | 13 |
| 8b | 50000 | 1.3 | 87.5% | 85% | 52 | 32 | 16 | 7 |

What is claimed is:

1. Anionic polymerization process for styrenic derivatives, where a styrenic monomer is placed in contact in a solvent with a catalytic system that includes at least:
one alkaline derivative (I) and
one alkyl magnesium derivative (II)
represented respectively by the formulae:
*R—X—Mₜ (I)
where R is an alkyl, cycloalkyl or aryl group, possibly replaced, and also able to carry heteroatoms, X is a heteroatom such as O, N, or S, or a carbon atom; and where Mₜ is an alkaline metal or alkaline earth metal, and
*R′—Mg—X—R″ (II)
where R′ and R″ are alkyl, cycloalkyl or aryl groups, possibly replaced, and also able to carry heteroatoms; X is a heteroatom such as O, N, or S, or a carbon atom, and Mg is an atom of magnesium.

2. Process according to claim 1, in which the ratio (I)(II) of the weighted amounts of type (I) and type (II) derivatives is included between 0.01 and 10.

3. Process according to claim 1, in which the solvent is a hydrocarbon.

4. Process according to claim 1, in which the solvent is an ether or THF.

5. Process according to claim 1, in which the styrene derivatives are stereospecifically copolymerized with dienes to form copolymer ₜPS-PD and ₜPS-PD-ₜPS blocks where ₜPS represents a PS block with controlled tacticity, and PD is a polydiene block.

6. Polystyrenes and polystyrene copolymers-polydiene block with controlled tacticity resulting from the process as described in claim 1.

7. Catalytic blend for anionic polymerization of styrenic derivatives including at least:
one alkaline derivative (I) and
one alkyl magnesium derivative (II)
represented respectively by the formulae:
*R—X—Mₜ (I)
where R is an alkyl, cycloalkyl or aryl group, possibly replaced, and also able to carry heteroatoms, X is a heteroatom such as O, N, or S, or a carbon atom; and where Mₜ is an alkaline metal or alkaline earth metal, and
*R′—Mg—X—R″ (II)
where R′ and R″ are alkyl, cycloalkyl or aryl groups, possibly replaced, and also able to carry heteroatoms; X is a heteroatom such as O, N, or S, or a carbon atom, and Mg is an atom of magnesium.
